(19) United States
(12) Patent Application Publication
(10) Pub. No.: US 2023/0004359 A1
(43) Pub. Date: Jan. 5, 2023

(54) COMPUTER-READABLE RECORDING MEDIUM STORING CONTRACT PROGRAM, CONTRACT METHOD, AND INFORMATION PROCESSING APPARATUS

(71) Applicant: FUJITSU LIMITED, Kawasaki-shi (JP)

(72) Inventors: Toshihiro Shimizu, Kawasaki (JP); Akihito Nakamura, Shinagawa (JP); Akihiro Kuwabara, Meguro (JP); Motohiro Kosaki, Kawasaki (JP)

(73) Assignee: FUJITSU LIMITED, Kawasaki-shi (JP)

(21) Appl. No.: 17/704,330

(22) Filed: Mar. 25, 2022

(30) Foreign Application Priority Data
Jun. 30, 2021 (JP) 2021-109266

(51) Int. Cl. G06F 7/72; G06F 11/10

(52) U.S. Cl. CPC G06F 7/724; G06F 7/721; G06F 11/10

(57) ABSTRACT

A recording medium stores a program causing a computer to execute a process including: setting, for each order having a condition that a contract count is designated, a polynomial having a contract count under the condition; representing an order status in which the orders are combined, with a polynomial on a finite field having a remainder obtained by dividing a coefficient of each term in a polynomial obtained by multiplying the polynomials corresponding to the orders; updating the polynomial on the finite field to a polynomial on a finite field representing an order status after a first order is combined, by multiplying the polynomial by a polynomial corresponding to the first order; and detecting an error in the polynomial after the update when a coefficient which is not 0 of a term in the polynomial before the update is 0 in the polynomial.

### CROSS-REFERENCE TO RELATED APPLICATION

This application is based upon and claims the benefit of priority of the prior Japanese Patent Application No. 2021-109266, filed on Jun. 30, 2021, the entire contents of which are incorporated herein by reference.

### FIELD

The embodiments discussed herein are related to a non-transitory computer-readable recording medium storing a contract program, a contract method, and an information processing apparatus.

### BACKGROUND

In a securities market, establishment of trading such as stock trading is called a “contract”. For example, a state in which conditions of a user who makes a sell order and a user who makes a buy order are matched and trading is established is referred to as a contract. In a case where a user makes an order (a sell order or a buy order), the user may make the order under a condition that a contract of a total amount is made or a contract of a certain order count is made.

Japanese Laid-open Patent Publication No. 2020-201726, Japanese Laid-open Patent Publication No. 2016-62112, and International Publication Pamphlet No. WO 2020/179069 are disclosed as related art.

### SUMMARY

According to an aspect of the embodiments, a non-transitory computer-readable recording medium stores a contract program causing a computer to execute a process including: setting, for each order having a condition that a contract count is designated, a polynomial having a contract count under the condition as an exponent; representing an order status in which the orders are combined, with a polynomial on a finite field having a remainder obtained by dividing a coefficient of each term in a polynomial obtained by multiplying the polynomials corresponding to the orders by a specific prime number; updating the polynomial on the finite field to a polynomial on a finite field representing an order status after a first order is combined, by multiplying the polynomial on the finite field by a polynomial corresponding to the first order; and detecting an error in the polynomial on the finite field representing the order status after the update in a case where a coefficient which is not 0 of a term in the polynomial on the finite field before the update is 0 in the polynomial on the finite field after the update.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram describing a process in a case where a sell order is accepted in dynamic programming;

FIG. 2 is an explanatory diagram describing a process in a case where a buy order is accepted in dynamic programming;

FIG. 3 is an explanatory diagram describing a process of calculating a contract count in dynamic programming;

FIG. 4 is an explanatory diagram describing a process in a case where a sell order is accepted in dynamic programming;

FIG. 5 is an explanatory diagram describing a process of specifying an order as a contract target in dynamic programming;

FIG. 6 is an explanatory diagram describing a case where an order status is represented by a polynomial;

FIG. 7 is an explanatory diagram describing a case where an order status is represented by a polynomial;

FIG. 8 is an explanatory diagram describing division in a case where an order status is represented by a polynomial;

FIG. 9 is a block diagram illustrating an example of a functional configuration of an information processing apparatus according to an embodiment;

FIG. 10 is an explanatory diagram illustrating an example of a data structure of a sell order table;

FIG. 11 is an explanatory diagram illustrating an example of a data structure of a buy order table;

FIG. 12 is an explanatory diagram illustrating an example of a data structure of contract result information;

FIG. 13 is a flowchart illustrating an example of an order reception and cancellation process;

FIG. 14 is a flowchart illustrating an example of a contract process;

FIG. 15 is an explanatory diagram describing error detection;

FIG. 16 is an explanatory diagram illustrating an example of first and second polynomial information; and

FIG. 17 is a block diagram illustrating an example of a hardware configuration of a computer that implements a function in the same manner as a function of the information processing apparatus according to the embodiment.

### DESCRIPTION OF EMBODIMENTS

A minimum limit contract count, which is a condition set for an order, is referred to as a “minimum contract count”. For example, in a case where there is a sell order having an order count “N” with a condition of a minimum contract count “M”, and there is a buy order having an order count equal to or greater than the order count “M”, trading is established. There is a related art for obtaining a contract by matching such a sell order and a buy order.

Meanwhile, in the related art described above, it is not checked whether or not there is an error in an order status of the sell order and the buy order of a contract target. For this reason, in the related art, for example, when the error is included in the order status, matching is performed as it is, and thus there is a problem that a correct contract result may not be obtained.

According to one aspect, an object is to provide a non-transitory computer-readable recording medium storing a contract program, a contract method, and an information processing apparatus capable of supporting acquisition of an accurate contract result.

Hereinafter, a non-transitory computer-readable recording medium storing a contract program, a contract method, and an information processing apparatus according to embodiments will be described below with reference to the drawings. In the embodiments, components having the same functions will be denoted by the same reference signs, and redundant description thereof will be omitted. The non-transitory computer-readable recording medium storing the contract program, the contract method, and the information processing apparatus to be described in the embodiments below are merely examples, and are not intended to limit the embodiment. Each embodiment below may be appropriately combined to the degree with which no inconsistency is caused.

First, a process of obtaining a contract by matching a sell order and a buy order with which the minimum contract count is set by dynamic programming will be described. In a process of specifying an order as a contract target by using dynamic programming, a Bool (T, F) array a is prepared for managing each of the sell order and the buy order, and an order as a contract target that maximizes a contract count is specified.

The Bool (T, F) array a is referred to as an “array a”. An index i equal to or greater than 0 is set for the array a, and ‘T’ or “F” is set for an element corresponding to the index i of the array a. A case where the element corresponding to the index i in the array a is “T” means that there is an order of an order count i. A case where the element corresponding to the index i in the array a is “F” means that there is no order of the order count i. “T” is an example of a registration symbol.

The case where the element of the index i in the array a is “T” is indicated by a [i]=T. The case where the element of the index i in the array a is “F” is indicated by a [i]=F.

An array a storing information on a sell order is referred to as a “first array a”, and an array a storing information on a buy order is referred to as a “second array a”.

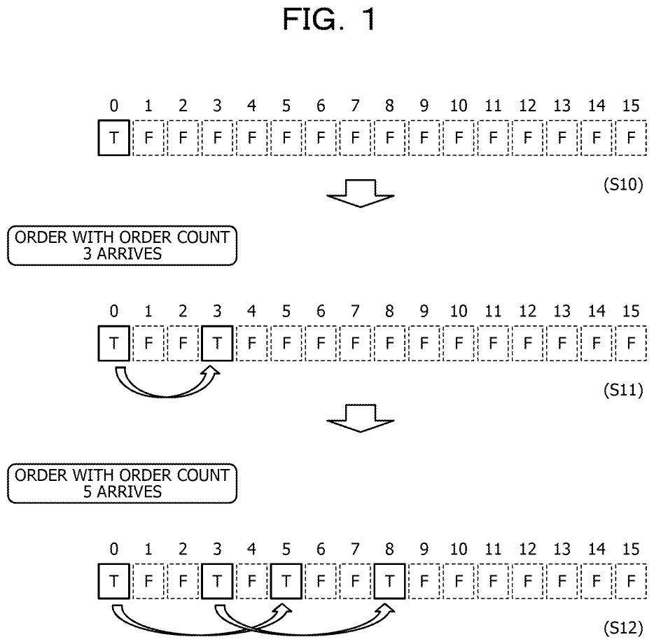

FIG. 1 is an explanatory diagram describing a process in a case where a sell order is accepted in dynamic programming, and illustrates a state of the first array a in a case where the sell order is accepted. An information processing apparatus sets a [i+x]=T in a case where a [i]=T and a sell order of an order count x is accepted.

An initial state of the first array a is illustrated in step S10. In the initial state of the first array a, a [0]=T, and all other elements are “F”.

In a case where a sell order having an order count 3 is accepted, a state of the first array a is as illustrated in step S11. Since the first array a is a [0]=T, the information processing apparatus sets a [0+3]=T.

In a case where an order having an order count 5 is accepted, the state of the first array a is as illustrated in step S12. Since the first array a is a [0]=T, the information processing apparatus sets a [0+5]=T. Since the first array a is a [3]=T, the information processing apparatus sets a [3+5]=T.

An index in which an element of the first array a is T indicates a matchable contract quantity. For example, in the state of the first array a in step S12 in FIG. 1, the element of the index i=8 is ‘T’, and “8” is a quantity for which contracts of a total amount of the order count “3” and the order count “5” are made.

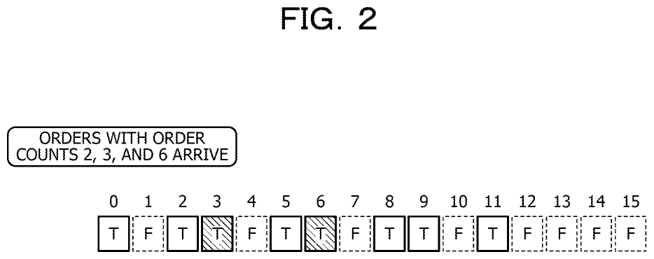

FIG. 2 is an explanatory diagram describing a process in a case where a buy order is accepted in dynamic programming, and illustrates a state of the second array a in a case where the buy order is accepted. In the same manner as the process for the first array a in a case where the sell order is accepted described with reference to FIG. 1, the information processing apparatus sets a [i+x]=T in a case where a [i]=T and a buy order of the order count x is accepted. In an initial state of the second array a, a [0]=T, and all other elements are “F”.

For example, in a case where a buy order having an order count 2, a buy order having an order count 3, and a buy order having an order count 6 are accepted in this order, the state of the second array a is as illustrated in FIG. 2. For example, a [0]=T, a [2]=T, a [3]=T, a [5]=T, a [6]=T, a [8]=T, a [9]=T, and a [11]=T, and the other elements are “F”.

The information processing apparatus compares the first array a of the sell orders described with reference to FIG. 1 and the second array a described with reference to FIG. 2, and specifies a maximum matchable contract quantity.

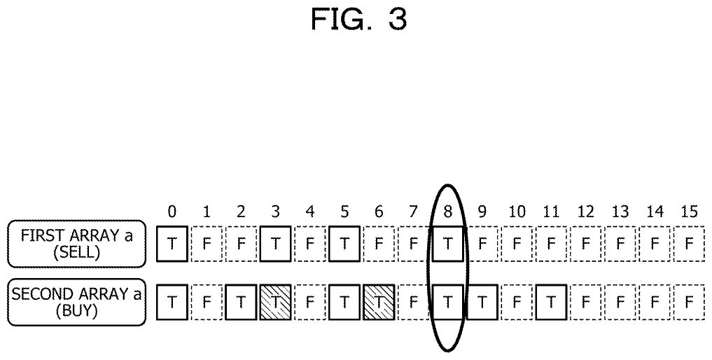

FIG. 3 is an explanatory diagram describing a process of calculating a contract count in dynamic programming. The information processing apparatus compares the first array a with the second array a, and specifies a largest index among indices in which both of an element of the first array a and an element of the second array a are ‘T’, as a maximum contract count. In the example illustrated in FIG. 3, since the largest index among the indices in which both of the element of the first array a and the element of the second array a are “T” is “8”, the information processing apparatus calculates the maximum matchable contract quantity as “8”.

Next, a process in which the information processing apparatus specifies an order to be a contract target will be described. In a case of accepting an order and setting “T” in an element of the array a for the first time, the information processing apparatus registers auxiliary information indicating an order reception sequence (order sequence) and a quantity (order count) for each index, and thus it is possible to specify an order as a contract target.

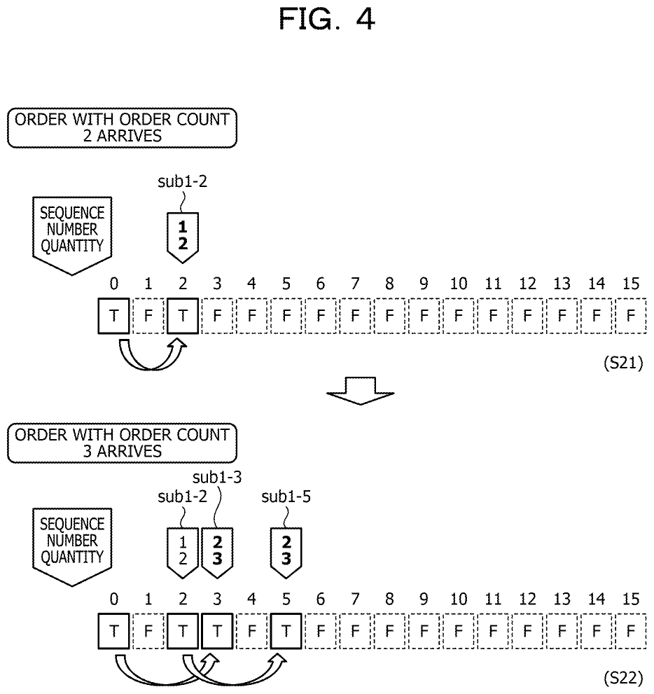

FIG. 4 is an explanatory diagram describing a process in a case where a sell order is accepted in dynamic programming. Although an initial state of the first array a is not illustrated in FIG. 4, the initial state of the first array a corresponds to the state of the first array a in step S10 described with reference to FIG. 1. The information processing apparatus does not give auxiliary information to an element of ‘T’ in the initial state. An order reception sequence of the sell order corresponds to a “first order sequence”, and an order count of the sell order corresponds to a “first order count”.

First (order reception sequence=1), in a case where a sell order having an order count 2 is accepted, a state of the first array a is as illustrated in step S21. Since the first array a in the initial state is a [0]=T, the information processing apparatus sets a [0+2]=T. Auxiliary information sub1-2 is registered at the index i=2. A sequence number “1” and a quantity “2” are set in the auxiliary information sub1-2.

Next (order reception sequence=2), in a case where a sell order having an order count 3 is accepted, the state of the first array a is as illustrated in step S22. Since the first array a is a [0]=T, the information processing apparatus sets a [0+3]=T, and registers auxiliary information sub1-3 to the index i=3. A sequence number “2” and a quantity “3” are set in the auxiliary information sub1-3.

Since the first array a is a [2]=T, the information processing apparatus sets a [2+3]=T, and registers auxiliary information sub1-5 to the index i=5. A sequence number “2” and a quantity “3” are set in the auxiliary information sub1-5.

Although not illustrated, also in a case where a buy order is accepted, the information processing apparatus sets ‘T’ in an element of the second array a, and registers auxiliary information in an index in the same manner as in FIG. 4. An order reception sequence of the buy order corresponds to a “second order sequence”, and an order count of the buy order corresponds to a “second order count”.

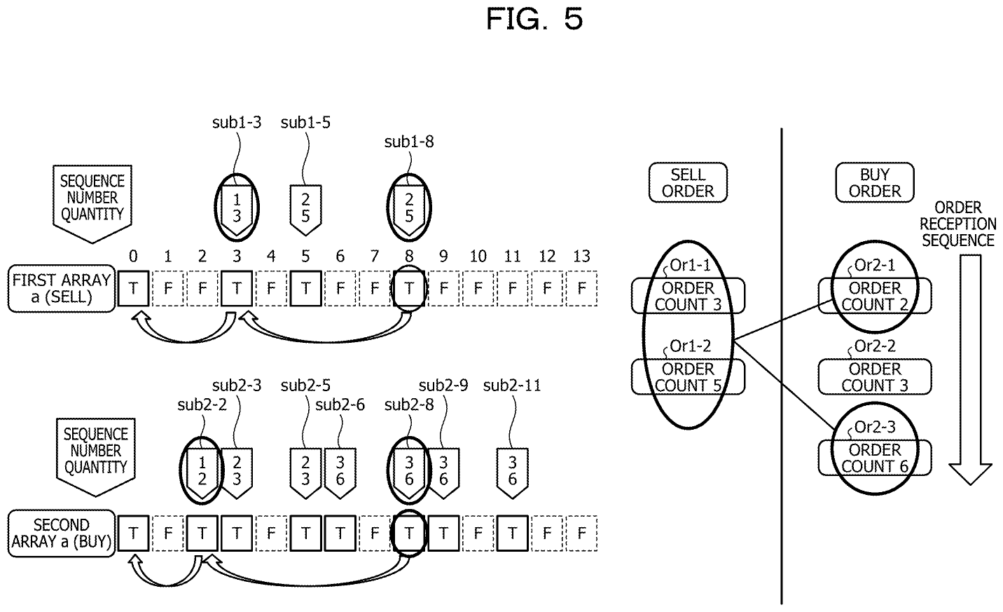

FIG. 5 is an explanatory diagram describing a process of specifying an order as a contract target in dynamic programming. As illustrated in FIG. 5, the information processing apparatus sequentially accepts orders Or1-1 and Or1-2 as sell orders. The order Or1-1 is an order having an order count “3”. The order Or1-2 is an order having an order count “5”. The information processing apparatus sequentially accepts orders Or2-1, Or2-2, and Or2-3 as buy orders. The order Or2-1 is an order having an order count “2”. The order Or2-2 is an order having an order count “3”. The order Or2-3 is an order having an order count “6”.

After accepting the orders Or1-1 and Or1-2 in order, the information processing apparatus executes the process on the first array a in a case where the sell order is accepted so as to set the first array a to the state as illustrated in FIG. 5. An element of the index i=0, 3, 5, and 8 of the first array a is “T”, and the other elements are “F”. “T” of the index i=0 is set in an initial state.

The information processing apparatus sets auxiliary information sub1-3 to the index i=3 in the first array a. A sequence number “1” and a quantity “3” are set in the auxiliary information sub1-3. The information processing apparatus sets auxiliary information sub1-5 to the index i=5 in the first array a. A sequence number “2” and a quantity “5” are set in the auxiliary information sub1-5. The information processing apparatus sets auxiliary information sub1-8 to the index i=8 in the first array a. A sequence number “2” and a quantity “5” are set in the auxiliary information sub1-8.

After accepting the orders Or2-1, Or2-2, and Or2-3 in order, the information processing apparatus executes a process on the second array a in a case where the buy order is accepted so as to set the second array a to the state as illustrated in FIG. 5. An element of the index i=0, 2, 3, 5, 6, 8, 9, and 11 in the second array a is ‘T’, and the other elements are “F”. “T” of the index i=0 is set in an initial state.

The information processing apparatus sets auxiliary information sub2-2 to the index i=2 in the second array a. A sequence number “1” and a quantity “2” are set in the auxiliary information sub2-2. The information processing apparatus sets auxiliary information sub2-3 to the index i=3 in the second array a. A sequence number “2” and a quantity “3” are set in the auxiliary information sub2-3. The information processing apparatus sets auxiliary information sub2-5 to the index i=5 in the second array a. A sequence number “2” and a quantity “3” are set in the auxiliary information sub2-5.

The information processing apparatus sets auxiliary information sub2-6 to the index i=6 in the second array a. A sequence number “3” and a quantity “6” are set in the auxiliary information sub2-6. The information processing apparatus sets auxiliary information sub2-8 to the index i=8 in the second array a. A sequence number “3” and a quantity “6” are set in the auxiliary information sub2-8. The information processing apparatus sets auxiliary information sub2-9 to the index i=9 in the second array a. A sequence number “3” and a quantity “6” are set in the auxiliary information sub2-9. The information processing apparatus sets auxiliary information sub2-11 to the index i=11 in the second array a. A sequence number “3” and a quantity “6” are set in the auxiliary information sub2-11.

The information processing apparatus compares the first array a with the second array a, and calculates a largest index among indices in which both of an element of the first array a and an element of the second array a are “T”, as a contract count. According to the example illustrated in FIG. 5, the largest index among the indices in which both the element of the first array a and the element of the second array a are ‘T’ is the index i=8. For this reason, the information processing apparatus sets the contract count to “8”.

After calculating the contract count, the information processing apparatus specifies an order as a contract target, based on the auxiliary information set in the array a. In a case of a contract with a contract count i0, the information processing apparatus sets an initial value of the index i=i0, and repeatedly executes the following process until i=0.

A process repeated by the information processing apparatus is the following process. The information processing apparatus treats an order with a [i]=T as a contract target. Next, the information processing apparatus specifies a quantity α included in the auxiliary information set in a [i], and updates the index i by i=i−α.

Based on the “first array a” in FIG. 5, a process in which the information processing apparatus specifies a sell order for a contract will be described.

The information processing apparatus treats, as a contract target, an order corresponding to the auxiliary information sub1-8 set to the index i=8 corresponding to the contract count “8”. The auxiliary information sub1-8 corresponds to the order Or1-2 with the sequence number “2” and the quantity “5”. The information processing apparatus acquires the quantity α=5 included in the auxiliary information sub1-8, and updates the index i=8-5=3.

The information processing apparatus treats an order corresponding to the auxiliary information sub1-3 set to index i=3 as a contract target. The auxiliary information 1-3 corresponds to the order Or1-1 with the sequence number “1” and the quantity “3”. The information processing apparatus acquires the quantity α=3 included in the auxiliary information sub1-3, and updates the index i=3-3=0. Since the index i=0, the information processing apparatus ends the process.

Based on the “second array a” in FIG. 5, a process in which the information processing apparatus specifies a buy order for a contract will be described.

The information processing apparatus treats, as a contract target, an order corresponding to the auxiliary information sub2-8 set to the index i=8 corresponding to the contract count “8”. The auxiliary information 2-8 corresponds to the order Or2-3 with the sequence number “3” and the quantity “6”. The information processing apparatus acquires the quantity α=6 included in the auxiliary information sub2-8, and updates the index i=8-6=2.

The information processing apparatus treats an order corresponding to the auxiliary information sub2-2 set to index i=2 as a contract target. The auxiliary information sub2-2 corresponds to the order Or2-1 with the sequence number “1” and the quantity “2”. The information processing apparatus acquires the quantity α=2 included in the auxiliary information sub2-2, and updates the index i=2-2=0. Since the index i=0, the information processing apparatus ends the process.

With the above-described process, the sell orders Or1-1 and Or1-2 and the buy orders Or2-1 and Or2-3 are specified as the contract targets.

In this manner, in a case where an array of order statuses related to remaining orders after an order as a contract target is specified or the order is canceled in dynamic programming, the array may not be obtained from the previously created array, and the array will be reconstructed each time. For this reason, there is a problem that efficiency in specifying an order as a contract target is poor, such as a memory for an index for specifying the order constituting the maximum contract is consumed.

In the present embodiment, the dynamic programming is regarded as multiplication (multiplication method) of a polynomial, and the dynamic programming is reduced to a polynomial. For example, in the information processing apparatus according to the present embodiment, each of accepted orders is represented by a polynomial having a contract count as an exponent, and an order status obtained by combining the respective orders is represented by multiplication of the polynomial of each order.

In the information processing apparatus according to the present embodiment, after an order as a contract target is specified, or after the order is canceled, subtraction of the orders is associated with division (division method) of the polynomial to obtain an order status related to the remaining order.

According to the present embodiment, by using the polynomial operation in this manner, it is possible to obtain the order status related to the remaining orders after specifying the order of the contract target or after canceling the order, without combining and reconstructing each order from the beginning. Accordingly, in the present embodiment, it is possible to efficiently specify the order as the contract target.

For example, an order with a condition that a contract count is k shares is represented by x^{k}. For example, 1=x⁰ corresponds to “no contract”, and x³ corresponds to “contract with 3 shares”. Whether or not a contract of the order with 3 shares is made is represented by multiplying (1+x³). In the same manner, whether or not a contract of an order with 2 shares is made is represented by multiplying (1+x²). A combination of the orders with 3 shares and 2 shares is represented by multiplication of (1+x³) and (1+x²) as follows, and it is understood that a contract may be executed with 0, 2, 3, and 5 shares by a polynomial after the multiplication.

(combination of orders with 3 shares and 2 shares)=(1+x³)(1+x²)=1+x²+x³+x⁵

In the operation of the polynomial, 1 corresponds to T and 0 correspond to F, and addition and multiplication are defined as follows. Addition is performed such that 0+0=0, 1+0=1, 0+1=1, and 1+1=1. Multiplication is performed such that 0*0=0, 1*0=0, 0*1=0, and 1*1=1.

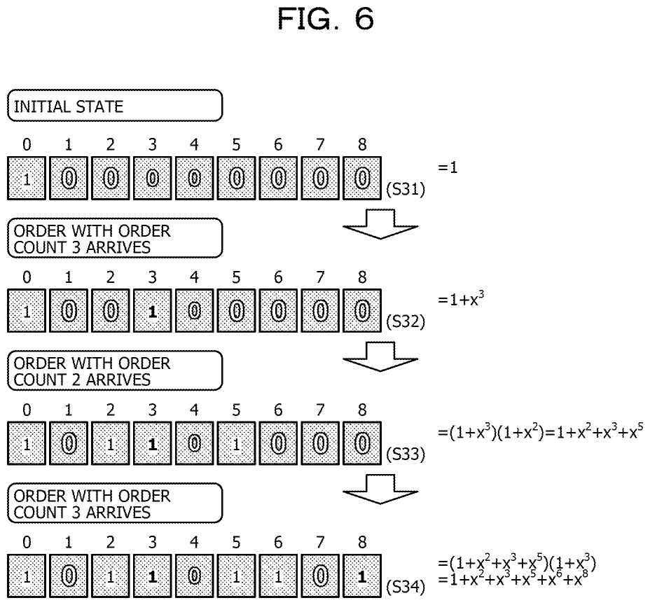

FIG. 6 is an explanatory diagram describing a case where an order status is represented by a polynomial. A left side of FIG. 6 illustrates data stored in a case where an order status of the array a is represented by a polynomial having a contract count as an exponent of x. In the illustrated example, coefficients in terms of exponents of 0 to 8 are stored in a [0] to a [8]. A right side of FIG. 6 illustrates the polynomial representing an order.

An initial state of the array a of the order statuses is illustrated in step S31. In the initial state of the array a, a [0]=1 corresponding to 1=x⁰ representing “no contract”, and all other elements are “0”.

Next, in a case where an order having an order count 3 is accepted (arrives), a state of the array a is as illustrated in step S32. The information processing apparatus multiplies 1 by (1+x³) of a polynomial corresponding to the order of the order count 3. Based on 1+x³ of the polynomial obtained by the multiplication, the information processing apparatus sets 1 to a [0] and a [3].

Next, in a case where an order having an order count 2 is accepted (arrives), the state of the array a is as illustrated in step S33. The information processing apparatus multiplies (1+x³) by (1+x²) of a polynomial corresponding to the order of the order count 2. Based on 1+x²+x³+x⁵ of the polynomial obtained by the multiplication, the information processing apparatus sets 1 to a [0], a [2], a [3], and a [5].

Next, in a case where an order having an order count 3 is accepted (arrives), the state of the array a is as illustrated in step S34. The information processing apparatus multiplies (1+x²+x³+x⁵) by (1+x³) of a polynomial of the order of the order count 3. Based on 1+x²+x³+x⁵+x⁶+x⁸ of the polynomial obtained by the multiplication, the information processing apparatus sets 1 to a [0], a [2], a [3], a [5], a [6], and a [8].

According to the above definition, there is no inverse operation (subtraction) for addition of T/F (0+0=0, 1+0=1, 0+1=1, and 1+1=1) and there is no inverse operation (division) for multiplication of T/F (0*0=0, 1*0=0, 0*1=0, and 1*1=1). In the present embodiment, the number system in the polynomial operation is changed to make the operation ready for reversibility. For example, a coefficient of each term in the polynomial operation is replaced with an integer on a finite field Fₚ, that is a remainder (mod p) divided with a specific prime number p. Therefore, the information processing apparatus of the present embodiment sets the polynomial representing the order status as a polynomial on a finite field, and obtains a state (polynomial) in which the order is canceled by an inverse operation (for example, division).

As an example, in a case where the prime number p is p=7 (mod 7), the prime number p is replaced with any integer of {0, 1, 2, 3, 4, 5, 6}. For example, addition is 3+5=8=1. Subtraction is 3−5=−2=5. Multiplication is 3*5=15=1. Division is 3/5=3*3=9=2 (since multiplication of 3 and 5 results in 1, “division by 5” is the same as “multiplication by 3”). In this manner, it is possible to handle as a set having a finite number of elements capable of addition, subtraction, multiplication, and division. In this manner, by setting the finite number, it becomes easy to handle in a computer operation. The prime number p used for an actual operation is a sufficiently large value to support the order count to be combined.

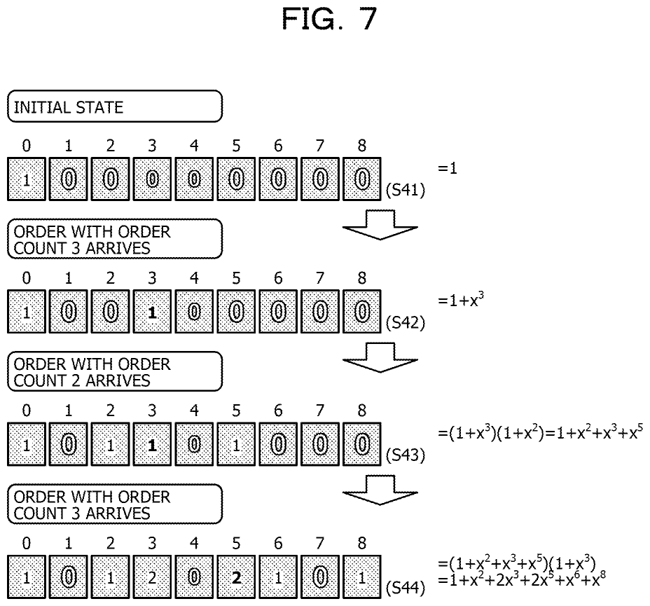

FIG. 7 is an explanatory diagram describing a case where an order status is represented by a polynomial. In the same manner as in FIG. 6, a left side of FIG. 7 illustrates the array a of order statuses, and a right side of FIG. 7 illustrates a polynomial representing an order.

An initial state of the array a of order statuses is illustrated in step S41. In the initial state of the array a, a [0]=1 corresponding to 1=x° representing “no contract”, and all other elements are “0”.

Next, in a case where an order having an order count 3 is accepted (arrives), a state of the array a is as illustrated in step S42. The information processing apparatus multiplies 1 by (1+x³) of a polynomial corresponding to the order of the order count 3. The information processing apparatus replaces a coefficient of each term with an integer on a finite field Fₚ divided by the prime number p (mod p) in an operation (for example, multiplication) of the polynomial. Based on 1+x³ of the polynomial obtained by the multiplication, the information processing apparatus sets 1 to a [0] and a [3] (all other elements are 0).

Next, in a case where an order having an order count 2 is accepted (arrives), the state of the array a is as illustrated in step S43. The information processing apparatus multiplies (1+x³) by (1+x²) of a polynomial corresponding to the order of the order count 2. Based on 1+x²+x³+x⁵ of the polynomial obtained by the multiplication, the information processing apparatus sets 1 to a [0], a [2], a [3], and a [5] (all the other elements are 0).

Next, in a case where an order having an order count 3 is accepted (arrives), the state of the array a is as illustrated in step S44. The information processing apparatus multiplies (1+x²+x³+x⁵) by (1+x³) of a polynomial of the order of the order count 3. Based on 1+x²+2x³+2x⁵+x⁶+x⁸ of the polynomial obtained by this multiplication, the information processing apparatus sets 1 to a [0] and a [2], sets 2 to a [3] and a [5], and sets 1 to a [6] and a [8](all the other elements are 0).

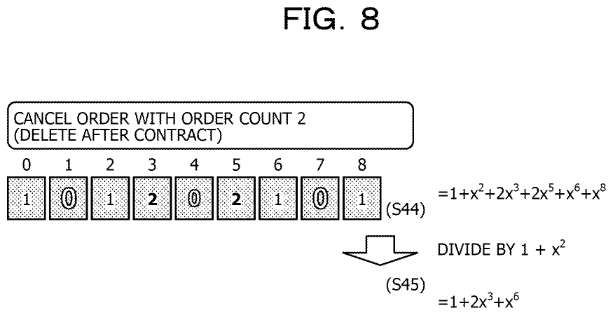

FIG. 8 is an explanatory diagram describing division in a case where an order status is represented by a polynomial. As illustrated in FIG. 8, in a case where the order having the order count 2 is canceled (or deleted after the contract) from the states of the orders in the array a in step S44, the information processing apparatus performs division by (1+x²). Therefore, the information processing apparatus updates the polynomial (array a) on a finite field representing the order status so as to indicate an order status after the contract or cancellation of the order having the order count 2.

For example, the information processing apparatus performs division on 1+x²+2x³+2x⁵+x⁶+x⁸ in the array a in step S44 by (1+x²). Based on 1+2x³+x⁶ of the polynomial obtained by this division, the information processing apparatus sets 1 to a [0] and a [6], and sets 2 to a [3](all the other elements are 0).

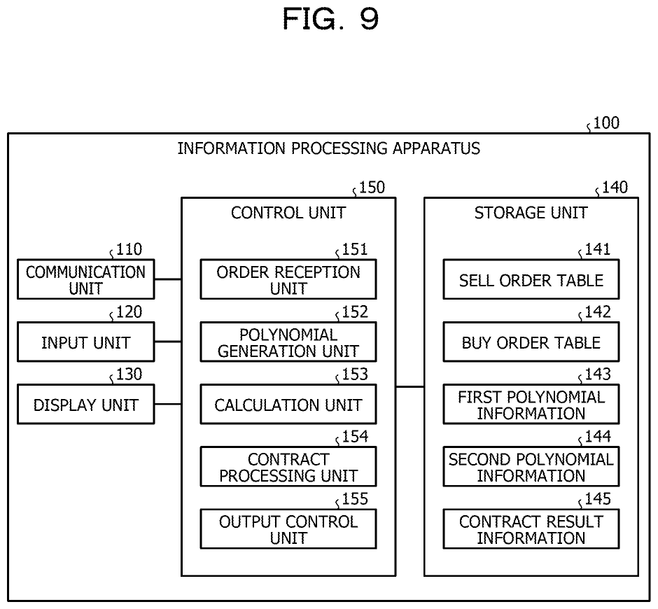

FIG. 9 is a block diagram illustrating an example of a functional configuration example of an information processing apparatus according to the embodiment. As illustrated in FIG. 9, an information processing apparatus 100 includes a communication unit 110, an input unit 120, a display unit 130, a storage unit 140, and a control unit 150.

The communication unit 110 is coupled to an external apparatus or the like in a wired or wireless manner, and transmits and receives information to and from the external apparatus or the like. The communication unit 110 is implemented by, for example, a network interface card (NIC) or the like. The communication unit 110 may be coupled to a network (not illustrated). For example, the communication unit 110 receives information on a sell order table 141 including information on sell orders, information on a buy order table 142 including information on buy orders, and the like from the external apparatus. For example, the external apparatus corresponds to a server that manages buying and selling of shares, and executes various types of processes related to an order as a contract target.

The input unit 120 is an input device that inputs various types of information to the information processing apparatus 100. The input unit 120 corresponds to a keyboard, a mouse, a touch panel, or the like.

The display unit 130 is a display device that displays information output from the control unit 150. The display unit 130 corresponds to a liquid crystal display, an organic electroluminescence (EL) display, a touch panel, or the like.

The storage unit 140 includes the sell order table 141, the buy order table 142, first polynomial information 143, second polynomial information 144, and contract result information 145. For example, the storage unit 140 is implemented by a semiconductor memory element such as a random-access memory (RAM) or a flash memory, or a storage device such as a hard disk or an optical disc.

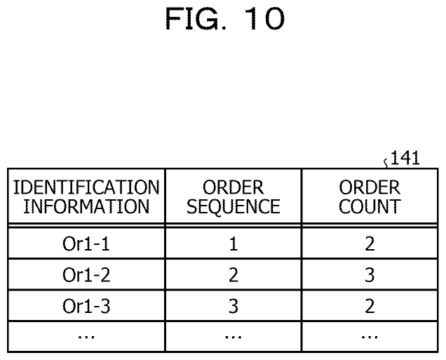

The sell order table 141 is a table in which an order sequence and an order count of the sell order are held. FIG. 10 is an explanatory diagram illustrating an example of a data structure of the sell order table 141. As illustrated in FIG. 10, in the sell order table 141, identification information, an order sequence, and an order count are associated with each other. The identification information is information for uniquely identifying an order. The order sequence is a sequence number of the accepted sell order. The order count is an order count of the sell order.

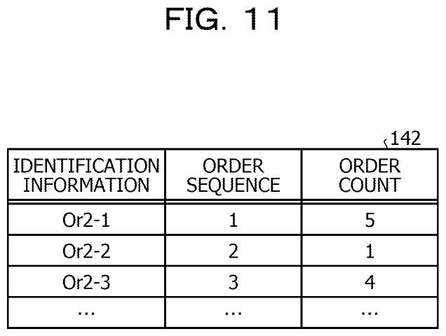

The buy order table 142 is a table in which an order sequence and an order count of the buy order are held. FIG. 11 is an explanatory diagram illustrating an example of a data structure of the buy order table 142. As illustrated in FIG. 11, in the buy order table 142, identification information, an order sequence, and an order count are associated with each other. The identification information is information for uniquely identifying an order. The order sequence is a sequence number of the accepted buy order. The order count is an order count of the buy order.

The first polynomial information 143 is array information holding information of a polynomial corresponding to an order status in which orders related to sell orders are combined. For example, the array information is array information of a polynomial (array a) on a finite field representing a status of the sell order, which is obtained by multiplying each sell order by the corresponding polynomial.

The second polynomial information 144 is array information holding information of a polynomial corresponding to an order status in which orders related to buy orders are combined. For example, the array information is array information of a polynomial (array a) on a finite field representing a status of the buy order, which is obtained by multiplying each buy order by the corresponding polynomial.

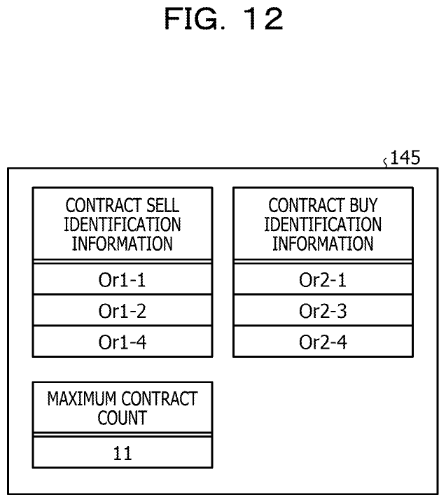

The contract result information 145 holds a maximum contract count and information on an order as a contract target. FIG. 12 is an explanatory diagram illustrating an example of a data structure of the contract result information 145. As illustrated in FIG. 12, the contract result information 145 includes contract sell identification information, contract buy identification information, and a maximum contract count. The contract sell identification information is information for identifying a sell order to be a contract target. The contract buy identification information is information for identifying a buy order to be a contract target. The maximum contract count indicates a contract count having the maximum count.

The control unit 150 includes an order reception unit 151, a polynomial generation unit 152, a calculation unit 153, a contract processing unit 154, and an output control unit 155. For example, the control unit 150 is implemented by a central processing unit (CPU) or a microprocessor unit (MPU). The control unit 150 may also be implemented by an integrated circuit such as an application-specific integrated circuit (ASIC) or a field-programmable gate array (FPGA), for example.

The order reception unit 151 is a processing unit that accepts an order having a designated condition for a contract count. After acquiring data of the sell order table 141 from an external apparatus or the like, the order reception unit 151 stores the data of the sell order table 141 in the storage unit 140. The order reception unit 151 may acquire sell orders individually and sequentially, and register information on the acquired sell orders in the sell order table 141.

In a case of acquiring data of the buy order table 142 from the external apparatus or the like, the order reception unit 151 stores the data of the buy order table 142 in the storage unit 140. The order reception unit 151 may acquire buy orders individually and sequentially, and register information on the acquired buy orders in the buy order table 142.

The order reception unit 151 may accept information (identification information) on an order to be canceled, and may delete information on a sell order or a buy order registered in the sell order table 141 or the buy order table 142. At this time, the order reception unit 151 acquires information on the order to be deleted from the sell order table 141 or the buy order table 142, and notifies the calculation unit 153 of the information.

The polynomial generation unit 152 is a processing unit that generates a polynomial on a finite field (hereafter, also referred to as an existing polynomial) representing an order status obtained by combining the accepted orders. For each of the accepted orders, the polynomial generation unit 152 sets a polynomial having a contract count (order count) under the condition designated in the order, as an exponent. Next, the polynomial generation unit 152 represents an order status obtained by combining the accepted orders with the polynomial (existing polynomial) on a finite field by a product of the polynomials.

For example, based on the sell order table 141 related to the sell orders, the polynomial generation unit 152 sets, for each of the sell orders, a polynomial having the order count designated by the sell order as an exponent. Next, the polynomial generation unit 152 multiplies the order status to be combined with the accepted sell order by a polynomial of each sell order. By setting a coefficient of the polynomial obtained by the multiplication as a remainder (mod p) of a specific prime number (p), the polynomial generation unit 152 generates a polynomial (first existing polynomial) on a finite field corresponding to the order status of the sell order. Next, the polynomial generation unit 152 stores information on the generated polynomial in the storage unit 140 as the first polynomial information 143.

Based on the buy order table 142 related to the buy orders, the polynomial generation unit 152 sets a polynomial having the order count designated by the buy order as an exponent, for each buy order. Next, the polynomial generation unit 152 multiplies the order status to be combined with the accepted buy order by a polynomial of each buy order. By setting a coefficient of the polynomial obtained by the multiplication as a remainder (mod p) of the specific prime number (p), the polynomial generation unit 152 generates a polynomial (second existing polynomial) on a finite field corresponding to the order status of the buy order. Next, the polynomial generation unit 152 stores information on the generated polynomial as the second polynomial information 144 in the storage unit 140.

The calculation unit 153 is a processing unit that performs various operation processes on a polynomial on a finite field representing an order status. For example, the calculation unit 153 divides the polynomial (existing polynomial) on a finite field representing the order status by a polynomial corresponding to an order for a contract or an order to be canceled, and updates to the existing polynomial representing an order status after the contract or the cancellation. For example, the calculation unit 153 performs division on the existing polynomial of the first polynomial information 143 or the second polynomial information 144 by a polynomial corresponding to the order specified as a contract target by the contract processing unit 154 or the order to be canceled (deleted) notified by the order reception unit 151. Next, the calculation unit 153 stores information on the existing polynomial after the division in the storage unit 140, as the first polynomial information 143 or the second polynomial information 144.

For example, in a case where the order for a contract or the order to be canceled is a sell order, the calculation unit 153 generates a polynomial corresponding to the sell order for a contract or the sell order to be canceled by a method in the same manner as the polynomial generation unit 152. Next, the calculation unit 153 performs division on the first existing polynomial in the first polynomial information 143 by the generated polynomial so as to obtain a first existing polynomial corresponding to a status of the sell order after the contract or after the cancellation. Next, the calculation unit 153 stores information on the obtained first existing polynomial as the first polynomial information 143 in the storage unit 140.

In a case where the order for a contract or the order to be cancelled is a buy order, the calculation unit 153 generates a polynomial corresponding to the buy order for a contract or the buy order to be cancelled by a method in the same manner as the polynomial generation unit 152. Next, the calculation unit 153 performs division on the second existing polynomial in the second polynomial information 144 by the generated polynomial so as to obtain a second existing polynomial corresponding to a status of the buy order after the contract or the cancellation. Next, the calculation unit 153 stores information on the obtained second existing polynomial as the second polynomial information 144 in the storage unit 140.

In a case where an order to be newly added is accepted by the order reception unit 151, the calculation unit 153 may multiply an existing polynomial by a polynomial of the order to update the existing polynomial to a polynomial representing an order status after the addition.

For example, in a case where the order which is newly added is a sell order, the calculation unit 153 generates a polynomial corresponding to the sell order to be added, by a method in the same manner as the polynomial generation unit 152. Next, the calculation unit 153 multiplies the first existing polynomial in the first polynomial information 143 by the generated polynomial to obtain a first existing polynomial corresponding to a status of the sell order after the addition. Next, the calculation unit 153 stores information on the obtained first existing polynomial as the first polynomial information 143 in the storage unit 140.

In a case where the order to be newly added is a buy order, the calculation unit 153 generates a polynomial corresponding to the buy order to be added, by a method in the same manner as the polynomial generation unit 152. Next, the calculation unit 153 multiplies the second existing polynomial in the second polynomial information 144 by the generated polynomial to obtain a second existing polynomial corresponding to a status of the buy order after the addition. Next, the calculation unit 153 stores information on the obtained second existing polynomial as the second polynomial information 144 in the storage unit 140.

The contract processing unit 154 is a processing unit that specifies an order to be a contract target, based on a maximum contract count, the first polynomial information 143, and the second polynomial information 144. A process of the contract processing unit 154 corresponds to the process described with reference to FIG. 5.

For example, as described with reference to FIG. 5, the contract processing unit 154 executes the above-described process on the first array a (first polynomial information 143) to specify the identification information Or1-1 and Or1-2 of the orders as a contract target. By executing the above-described process on the second array a (second polynomial information 144), the contract processing unit 154 specifies the identification information Or2-1 and Or2-3 of the orders as a contract target.

Next, the contract processing unit 154 registers identification information of the order specified as a contract target by executing the above-described process, in the contract result information 145. The contract processing unit 154 acquires the information on the order of the contract target from the sell order table 141 or the buy order table 142, and notifies the calculation unit 153 of the information.

The output control unit 155 is a processing unit that outputs the contract result information 145 to the display unit 130 so as to display the contract result information 145. The output control unit 155 may transmit the contract result information 145 to an external apparatus, and request the external apparatus to execute various contract processes.

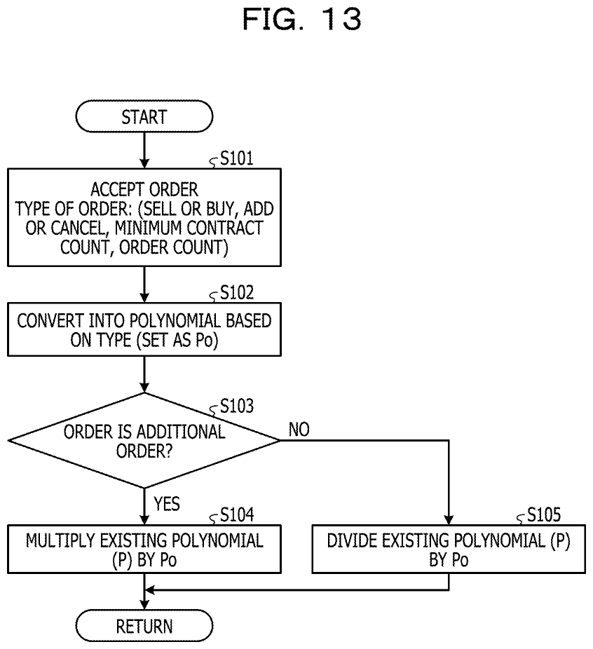

FIG. 13 is a flowchart illustrating an example of an order reception and cancellation process. As illustrated in FIG. 13, when the process is started, the order reception unit 151 accepts an order having a designated condition for a contract count (S101). A type (condition) of the order accepted in S101 includes a sell order or a buy order, addition or deletion of the order, a minimum contract count, an order count, and the like.

Next, based on the type (condition) of the accepted order, the polynomial generation unit 152 converts the order into a polynomial (Po) having a contract count (order count) under the condition designated in the order as an exponent (S102). In a case where the condition of the contract count has a range such as a case where a minimum contract count is a shares (for example, 3 shares) and an order count is b shares (for example, 5 shares), the polynomial generation unit 152 converts the order into a polynomial having the contract count of a to b shares as an exponent. For example, the polynomial generation unit 152 performs conversion into a polynomial of 1+x^{a}+x^{a+1}+x^{a+2}+ . . . +x^{b}.

Next, the calculation unit 153 determines whether or not the accepted order is an additional order (S103). In a case of the additional order (Yes in S103), the calculation unit 153 reads the first polynomial information 143 when the additional order is a sell order and the second polynomial information 144 when the additional order is a buy order, and acquires an existing polynomial (P). Next, the calculation unit 153 multiplies the acquired existing polynomial (P) by the polynomial (Po) (S104). Next, the calculation unit 153 updates the first polynomial information 143 or the second polynomial information 144 with the existing polynomial (P) after the multiplication, and ends the process.

In a case where the order is not an additional order but is canceled (No in S103), the calculation unit 153 reads the first polynomial information 143 in a case where the order to be canceled is a sell order, and reads the second polynomial information 144 in a case where the order to be canceled is a buy order, and acquires the existing polynomial (P). Next, the calculation unit 153 divides the acquired existing polynomial (P) by the polynomial (Po) (S105). Next, the calculation unit 153 updates the first polynomial information 143 or the second polynomial information 144 with the existing polynomial (P) after the division, and ends the process.

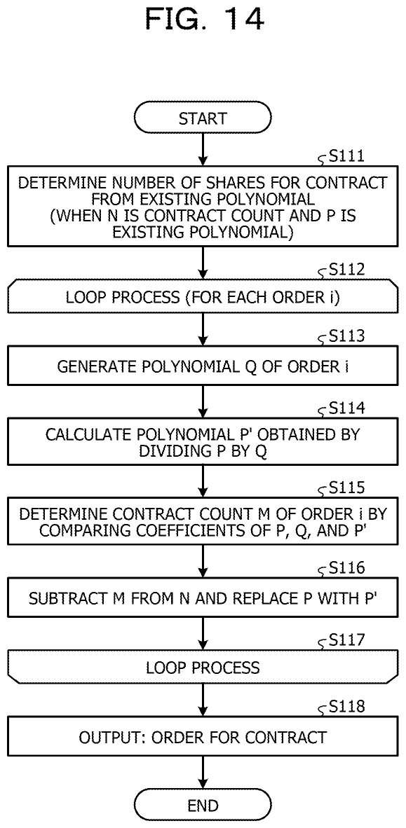

FIG. 14 is a flowchart illustrating an example of a contract process. As illustrated in FIG. 14, when the process is started, the contract processing unit 154 determines the number of shares for a contract based on an existing polynomial (a first existing polynomial and a second existing polynomial) of the first polynomial information 143 and the second polynomial information 144 (S111). For example, the contract processing unit 154 compares the first existing polynomial with the second existing polynomial, and determines a maximum number (maximum exponent) that is T for each other (a coefficient other than 0 is set) as the number of shares for a contract. The determined contract count is N, and the existing polynomial is P.

Next, for each of a sell order and a buy order, the contract processing unit 154 executes a loop process (S112 to S117) on the order as a contract target to specify an order for a contract. For example, in the case of FIG. 5, the sell orders of the identification information Or1-1 and Or1-2 and the buy orders of Or2-1 and Or2-3 are orders as contract targets. The contract processing unit 154 performs the loop process in which each of these orders is set as i.

For example, the contract processing unit 154 generates a polynomial Q, based on a condition of the order i (S113). Next, the calculation unit 153 calculates a polynomial P′ by dividing the existing polynomial P (the first existing polynomial in a case where the order i is a sell order, and the second existing polynomial in a case where the order i is a buy order) by the polynomial Q (S114).

Next, the contract processing unit 154 determines a contract count M for the order i by comparing coefficients of the P, Q, and P′ (S115). Assuming that a coefficient of x^{N} of P(x) is c in a polynomial operation P(x)=Q(x)*P′(x), when c is not 0, there is a case where c₁≠c₂ at c₁x^{N-M} of Q(x) and c₂x^{N} of P(x). The contract processing unit 154 determines M that satisfies the above-described condition. A case where M is 0 represents that a contract of 0 shares is made, for example, a contract of the order i is not made.

Next, the contract processing unit 154 subtracts the determined contract count M from N, and replaces the existing polynomial P with P′ (S116).

Next, after the loop process (S112 to S117), the contract processing unit 154 outputs the specified order for a contract (S118), and ends the process.

As described above, the information processing apparatus 100 accepts an order having a designated condition for a contract count. For each of the accepted orders, the information processing apparatus 100 uses a polynomial of which exponent is the contract count under the designated condition. The information processing apparatus 100 represents an order status obtained by combining the accepted orders by a polynomial on a finite field by a product of the polynomials. The information processing apparatus 100 performs division on the polynomial on the finite field representing the order status by a polynomial corresponding to an order for a contract or an order to be canceled, and updates to the polynomial on the finite field representing an order status after the contract or after the cancellation.

Therefore, in the information processing apparatus 100, it is possible to obtain the order status related to the remaining orders after specifying the order of the contract target or after canceling the order, without combining and reconstructing each order from the beginning. Accordingly, with the information processing apparatus 100, it is possible to efficiently specify the order to be the contract target.

The information processing apparatus 100 represents a buy order status obtained by combining the accepted buy orders by a first polynomial on a finite field by a product of the polynomials. The information processing apparatus 100 represents a sell order status obtained by combining the accepted sell orders by a second polynomial on a finite field by a product of the polynomials. Therefore, in the information processing apparatus 100, it is possible to efficiently obtain, for each of the buy order status in which the buy orders are combined and the sell order status in which the sell orders are combined, an order status after specifying the order as a contract target or after cancelling the order.

The calculation unit 153 may determine whether or not to adopt the existing polynomial after the division as the existing polynomial representing the order status after the contract or the cancellation based on a coefficient of a term of a specific exponent. For example, as a result obtained by dividing the existing polynomial by the polynomial corresponding to the order as a contract target or a cancellation target, the calculation unit 153 adopts the polynomial when the coefficient of the specific term is not 0, and does not adopt the polynomial when the coefficient is 0.

As an example, a contract with 6 shares in a case where the existing polynomial is 1+x²+2x³+2x⁵+x⁶+x⁸ (available since a coefficient of x⁶ is not 0) is considered. When it is desired to determine whether or not an order with 2 shares is included in this contract, the original equation (existing polynomial described above) is divided by 1+x². Next, since a coefficient of a term of x⁴ (for 4 shares from 6-2=4) in 1+2x³+x⁶ as a result of the division is 0, it is understood that the order is not included.

In this manner, the calculation unit 153 may determine adoption or non-adoption, based on a coefficient of a specific term in the existing polynomial after the division. In a case of non-adoption, the calculation unit 153 may cause the output control unit 155 to notify an error, or may return the process to the contract processing unit 154 so that another order becomes a contract target.

In the processes in S104 and S105, the calculation unit 153 may check whether there is an error in the order status of the sell order and the buy order. For example, in a case where the prime number p in the finite field is smaller than the number of combinations of orders, an information loss may occur and the coefficient in the existing polynomial after the operation may be a false positive. In this manner, in a case where the order status includes the error, if matching is performed as it is, a correct contract result may not be obtained.

As an example, in a case where a remainder of each coefficient is calculated with the prime number p for each update of a polynomial on a finite field, a probability of 0 is estimated as 1/p. Even when p is a 64-bit integer and 100 million updates are executed per day, a probability of occurrence of a false positive in the updates is approximately 1/2⁶⁴=5.42×10⁻¹². Meanwhile, in a case where the number of cases where orders are combined is increased, a probability that a false positive occurs is increased, and a case where a correct contract result may not be obtained may occur.

In a case where a term in which a coefficient, which is not 0, of a term in a polynomial on a finite field before an update by multiplication or division is 0 in the polynomial on the finite field after the update, there is a possibility that the coefficient is a false positive, so that the calculation unit 153 detects an error in the polynomial on the finite field representing an order status after the update.

In this manner, the information processing apparatus 100 may detect the error in the polynomial on the finite field indicating the order status in which the sell order and the buy order are combined. Since the error in the order status is detectable, for example, the information processing apparatus 100 may support acquisition of an accurate contract result by performing a process such as avoiding matching as it is in a case where the error is detected.

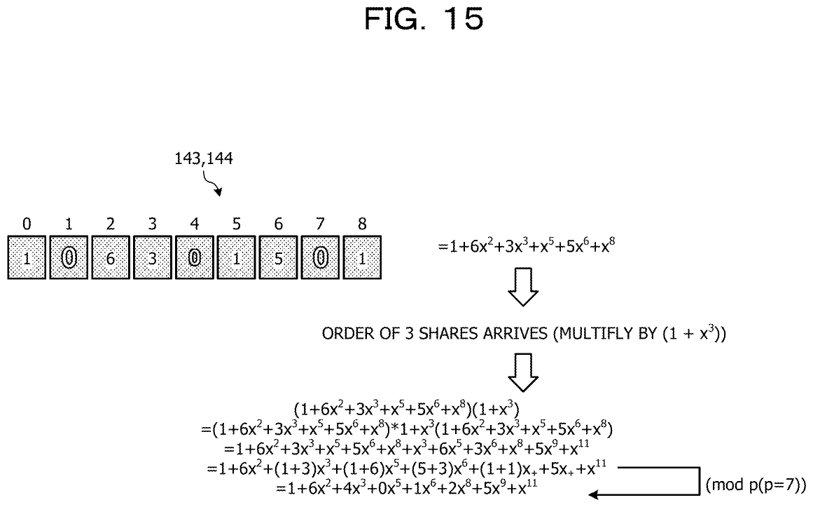

FIG. 15 is an explanatory diagram describing error detection. As illustrated in FIG. 15, it is assumed that a polynomial of an order status indicated by the first polynomial information 143 and the second polynomial information 144 is 1+6x²+3x³+x⁵+5x⁶+x⁸ as an example. In a case where an order of 3 shares arrives, the calculation unit 153 performs the above-described process in S104, and multiplies the order of 3 shares by a corresponding polynomial (1+x³) to update the order of 3 shares to a polynomial on a finite field indicating an order status in which the accepted order is combined.

For example, for a coefficient of each term of a polynomial after multiplication, the calculation unit 153 obtains the polynomial on a finite field indicating an order status after combining orders, by using a remainder (mod p (p=7)) divided with the specific prime number p.

Although multiplication of the additional order is illustrated in the example in FIG. 15, the order of 3 shares may be removed. For example, the calculation unit 153 may perform the above-described process in S105, and performs division with a polynomial (1+x³) corresponding to the order of 3 shares to update to a polynomial on a finite field indicating an order status after the order is removed.

The calculation unit 153 compares a coefficient of each term in the polynomial on the finite field before the update by multiplication or division with a coefficient of each term in the polynomial on the finite field after the update. By this comparison, the calculation unit 153 determines whether or not the term which is not 0 is 0 after the update.

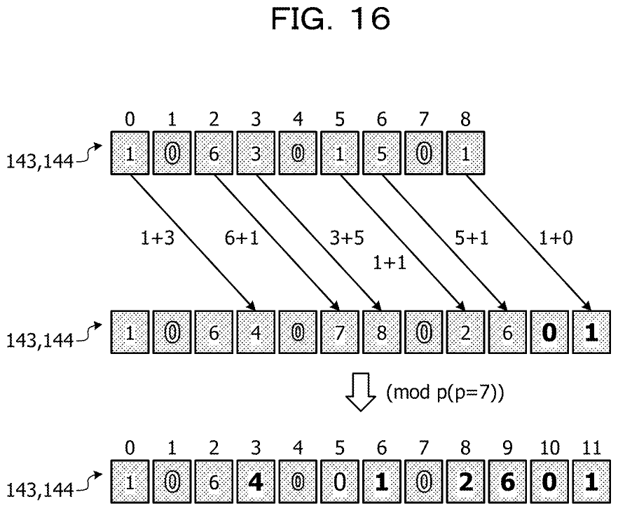

FIG. 16 is an explanatory diagram illustrating an example of first and second polynomial information. As illustrated in an upper part in FIG. 16, it is assumed that contents of the polynomial illustrated in FIG. 15 are stored in the first polynomial information 143 and the second polynomial information 144 before an update. The calculation unit 153 performs an operation of mod p (p=7) by multiplying with the polynomial (1+x³) corresponding to the order of 3 shares. Therefore, the first polynomial information 143 and the second polynomial information 144 after the update have contents as illustrated in a lower part in FIG. 16.

By comparing the first polynomial information 143 and the second polynomial information 144 before the update (upper part in FIG. 16) with the first polynomial information 143 and the second polynomial information 144 after the update (lower part in FIG. 16), the calculation unit 153 determines whether or not a term which is not 0 is 0 after the update. In the illustrated example, a coefficient corresponding to a term of x⁵ is changed from 5 to 0. Therefore, the calculation unit 153 detects an error in the polynomial on the finite field representing an order status after the update.

In a case where the error is detected, the calculation unit 153 replaces the specific prime number (p) with another prime number (p′, for example, p′>p), and then recalculates a polynomial on a finite field. In this manner, in a case where the error is detected, the calculation unit 153 may perform recalculation by replacing the prime number to avoid a case where the coefficient is a false positive. In a case where the error is detected, the calculation unit 153 may perform switching into a contract by dynamic programming described above. In a case where the error is detected, the calculation unit 153 may notify a user of occurrence of the error during calculation via the output control unit 155 without performing matching for obtaining the contract.

As described above, the information processing apparatus 100 sets each order for which a condition of a contract count is designated, as a polynomial having the contract count under the condition as an exponent. The information processing apparatus 100 represents an order status in which the orders are combined, with a polynomial on a finite field having a remainder obtained by dividing a coefficient of each term in a polynomial obtained by a method of multiplying polynomials corresponding to the orders by a specific prime number. By multiplying the polynomial on the finite field by a polynomial corresponding to a specific order, the information processing apparatus 100 updates to a polynomial on a finite field representing an order status after the specific order is combined. The information processing apparatus 100 detects an error in the polynomial on the finite field representing the order status after the update in a case where a coefficient which is not 0 of a term in the polynomial on the finite field before the update is 0 in the polynomial on the finite field after the update.

Therefore, in the information processing apparatus 100, it is possible to detect an error in which a prime number in a finite field is smaller than the number of combinations in which orders are combined, an information loss occurs, and a coefficient in a polynomial on the finite field after an operation becomes a false positive. Since the error in the order status is detectable in this manner, for example, the information processing apparatus 100 may support acquisition of an accurate contract result by performing a process such as avoiding matching as it is in a case where the error is detected.

The updating process of the information processing apparatus 100 includes a process of updating a polynomial on a finite field representing an order status after a specific order is removed, by dividing the polynomial on the finite field by a polynomial corresponding to the specific order. Therefore, with the information processing apparatus 100, it is possible to detect an error in a polynomial on a finite field representing an order status, after the update, after the specific order is removed by the division.

In a case where the error is detected, the information processing apparatus 100 replaces a specific prime number with another prime number, and then recalculates a polynomial on a finite field. In this manner, with the information processing apparatus 100, in a case where the error is detected, by performing recalculation by changing the prime number, it is possible to avoid a case where a coefficient is a false positive in the polynomial on the finite field.

It is noted that each component of each apparatus illustrated in the drawings may not be physically configured as illustrated in the drawings. For example, specific forms of the separation and integration of each apparatus are not limited to those illustrated in the drawings. The entirety or part of the apparatus may be configured by functionally or physically separating into arbitrary units or integrating into an arbitrary unit in accordance with various loads, usage situations, and the like.

Although the present embodiment exemplifies a case to be applied to the case where an order is made under a condition of a total amount contract or a certain order count in stock trading in the securities trading market, the present embodiment is not limited to the application to the stock trading. For example, the present embodiment may be applied to trading other than stock trading, such as futures trading markets.

All or certain some of the various processing functions to be executed by the information processing apparatus 100 may be executed by a CPU (or a microcomputer such as an MPU or a micro controller unit (MCU)) or a graphics processing unit (GPU). Of course, all or arbitrary subset of the various processing functions may be executed in programs analyzed and executed by the CPU (or a microcomputer such as the MPU or MCU) or the GPU or may be executed in hardware using wired logic. The various processing functions performed in the information processing apparatus 100 may be executed in such a way that a plurality of computers cooperate with each other via cloud computing.

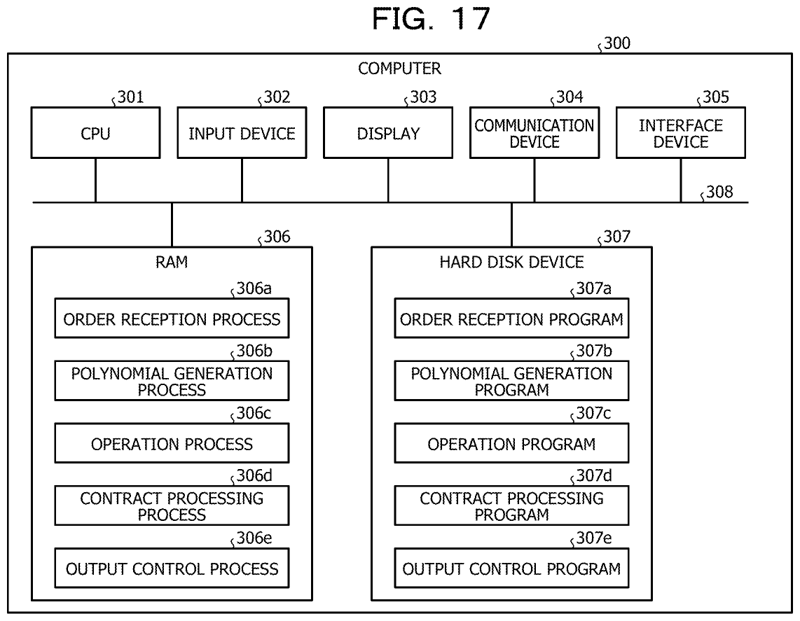

Next, an example of a hardware configuration of a computer that implements functions similar to those of the information processing apparatus 100 described in the above embodiment will be described. FIG. 17 is a diagram illustrating an example of a hardware configuration of a computer that implements a function in the same manner as a function of the information processing apparatus 100 according to the embodiment.

As illustrated in FIG. 17, a computer 300 includes a CPU 301 which executes various operation processes, an input device 302 which accepts an input of data from a user, and a display 303. The computer 300 includes a communication device 304 that exchanges data with an external apparatus or the like via a wired or wireless network, and an interface device 305. The computer 300 also includes a RAM 306 that temporarily stores various kinds of information and a hard disk device 307. Each of devices (301 to 307) is coupled to a bus 308.

The hard disk device 307 includes an order reception program 307a, a polynomial generation program 307b, an operation program 307c, a contract processing program 307d, and an output control program 307e. The CPU 301 reads each of the programs 307a to 307e, and expands the program into the RAM 306.

The order reception program 307a functions as an order reception process 306a. The polynomial generation program 307b functions as a polynomial generation process 306b. The operation program 307c functions as an operation process 306c. The contract processing program 307d functions as a contract processing process 306d. The output control program 307e functions as an output control process 306e.

A process of the order reception process 306a corresponds to the process of the order reception unit 151. A process of the polynomial generation process 306b corresponds to the process of the polynomial generation unit 152. A process of the operation process 306c corresponds to the process of the calculation unit 153. A process of the contract processing process 306d corresponds to the process of the contract processing unit 154. A process of the output control process 306e corresponds to the process of the output control unit 155.

Each of the programs 307a to 307e may not be stored in the hard disk device 307 from the beginning. For example, each program may be stored in a “portable physical medium” such as a flexible disk (FD), a compact disc read-only memory (CD-ROM), a Digital Versatile Disc (DVD), a magneto-optical disk, an IC card, or the like inserted in the computer 300. The computer 300 may read and execute each of the programs 307a to 307e. Each of the programs 307a to 307e may be stored in an external apparatus coupled to a network such as a public line, the Internet, a LAN, or the like, and each of the programs 307a to 307e may be read from the external apparatus coupled to the network and executed by the computer 300.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a contract program causing a computer to execute a process comprising:
setting, for each order having a condition that a contract count is designated, a polynomial having a contract count under the condition as an exponent;
representing an order status in which the orders are combined, with a polynomial on a finite field having a remainder obtained by dividing a coefficient of each term in a polynomial obtained by multiplying the polynomials corresponding to the orders by a specific prime number;
updating the polynomial on the finite field to a polynomial on a finite field representing an order status after a first order is combined, by multiplying the polynomial on the finite field by a polynomial corresponding to the first order; and
detecting an error in the polynomial on the finite field representing the order status after the update in a case where a coefficient which is not 0 of a term in the polynomial on the finite field before the update is 0 in the polynomial on the finite field after the update.

2. The non-transitory computer-readable recording medium according to claim 1,
wherein in the updating, the polynomial on the finite field is updated to a polynomial on a finite field representing an order status after a second order is deleted, by dividing the polynomial on the finite field by a polynomial corresponding to the second order.

3. The non-transitory computer-readable recording medium according to claim 1, the contract program causing the computer to execute the process further comprising:
recalculating, in a case where an error is detected, the polynomial on the finite field after replacing the specific prime number with another prime number.

4. A contract method comprising:
setting, by a computer, for each order having a condition that a contract count is designated, a polynomial having a contract count under the condition as an exponent;
representing an order status in which the orders are combined, with a polynomial on a finite field having a remainder obtained by dividing a coefficient of each term in a polynomial obtained by multiplying the polynomials corresponding to the orders by a specific prime number;
updating the polynomial on the finite field to a polynomial on a finite field representing an order status after a first order is combined, by multiplying the polynomial on the finite field by a polynomial corresponding to the first order; and
detecting an error in the polynomial on the finite field representing the order status after the update in a case where a coefficient which is not 0 of a term in the polynomial on the finite field before the update is 0 in the polynomial on the finite field after the update.

5. The contract method according to claim 4,
wherein in the updating, the polynomial on the finite field is updated to a polynomial on a finite field representing an order status after a second order is deleted, by dividing the polynomial on the finite field by a polynomial corresponding to the second order.

6. The contract method according to claim 4, further comprising:
recalculating, in a case where an error is detected, the polynomial on the finite field after replacing the specific prime number with another prime number.

7. An information processing apparatus comprising:
a memory; and
a processor coupled to the memory and configured to:
set, for each order having a condition that a contract count is designated, a polynomial having a contract count under the condition as an exponent;
represent an order status in which the orders are combined, with a polynomial on a finite field having a remainder obtained by dividing a coefficient of each term in a polynomial obtained by multiplying the polynomials corresponding to the orders by a specific prime number;
update the polynomial on the finite field to a polynomial on a finite field representing an order status after a first order is combined, by multiplying the polynomial on the finite field by a polynomial corresponding to the first order; and
detect an error in the polynomial on the finite field representing the order status after the update in a case where a coefficient which is not 0 of a term in the polynomial on the finite field before the update is 0 in the polynomial on the finite field after the update.

8. The information processing apparatus according to claim 7,
wherein the polynomial on the finite field is updated to a polynomial on a finite field representing an order status after a second order is deleted, by dividing the polynomial on the finite field by a polynomial corresponding to the second order.

9. The contract method according to claim 7, wherein the processor recalculates, in a case where an error is detected, the polynomial on the finite field after replacing the specific prime number with another prime number.
